(19) United States
(12) Patent Application Publication
(10) Pub. No.: US 2018/0126748 A1
(43) Pub. Date: May 10, 2018

(54) COMPACT PLATEN ROLLER MOTION SYSTEM FOR THERMAL PRINTING MECHANISM

(71) Applicant: APS TRADING OOD, Botevgrad (BG)

(72) Inventor: Denis Montagutelli, Angers (FR)

(21) Appl. No.: 15/566,986

(22) PCT Filed: May 11, 2016
(86) PCT No.: PCT/EP2016/060534

§ 371 Date: Oct. 16, 2017

(30) Foreign Application Priority Data
May 19, 2015 (EP) 15168283.8

(51) Int. Cl. B41J 2/32; B41J 11/04; B41J 23/02

(52) U.S. Cl. CPC B41J 2/32; B41J 23/02; B41J 11/04

(57) ABSTRACT

Thermal printing mechanism having a printer chassis, a thermal printhead, a motor for rotating a platen roller with a motor spur gear, a platen roller with a platen roller gear mounted on it, the platen roller gear being a worm wheel able to engage with a worm screw. The motor is mounted so that its gear axis is substantially parallel to the thermal printhead surface which is in contact with the platen roller, and perpendicular to the platen roller shaft. The thermal printing mechanism additionally includes a gear shaft mounted substantially parallel to the motor gear axis, the gear shaft having at one end a spur gear able to engage with the motor spur gear, and at the other end a worm screw, able to engage with the platen roller gear.

### TECHNICAL FIELD OF THE INVENTION

The present invention is in the field of the thermal printing mechanisms. Such printers are widely used in handheld payment terminals where compactness and cost are the main factors of improvements.

### PRIOR ART

A thermal printing mechanism usually comprises a chassis for holding all of the following components: a thermal printhead, a platen roller that can be put in rotation by a motor trough a gear train, and pushing means in order to keep under pressure the thermal printhead against the platen roller. A thermal sensitive paper is inserted between the platen roller and the thermal printhead, and the printout is generated by combining the paper advance with the dot selection and activation on the thermal printhead.

An improvement of such device is providing the possibility to separate the platen roller from the thermal printhead and the chassis in order to facilitate the loading of the paper and its positioning between the thermal printhead and the platen roller. In such arrangement the platen roller has two positions: first one called the printing position, where the platen roller is held in the printer chassis and allows the printer to print, and second one—called open position wherein the platen roller is detached from the printer chassis. Such arrangements of a thermal printing mechanism are well known in the prior art, and described for example in FR2786727.

In such mechanisms, the motor, which is usually a stepper motor, is mounted parallel to the thermal printhead dotline, and behind it, in a so called horizontal motor variant, or underneath it in a so called vertical motor variant, and a spur gear train is mounted in a direction parallel to the printer flange to keep the printer width as small as possible. Sometimes the spur gear train is replaced by a worm screw (FR 2 923 411) to reduce the gearbox size, but even in this variant, the motor is laid on the printer frame and kept aligned with the thermal printhead, and the gear box remains on the printer flange.

The thickness of the gearbox is usually in the range of 7 to 8 mm, and cannot be reduced, due to the fact that several gears have to be piled up, and even in the case of the use of a worm screw (FR 2 923 411), where the motor is in the horizontal variant, the worm screw is mounted horizontally, so in a position which is not in favourable to a gear box thickness reduction, and this leads to the same gearbox thickness range.

In the cases where small diameter stepper motor is used, usually 10 mm, the heat dissipation becomes problematic, and some special arrangement have to be done in order to evacuate the heat generated by the motor when the printer is printing. The patent FR2 837 423 describes such a variant, where on additional metal part is mounted on the motor to dissipate the heat.

### SUMMARY OF THE INVENTION

The aim of the present invention is to reduce the global volume of a small thermal printing mechanism by simplifying the motion means, reducing the number of parts and simplifying its construction while offering optimized dimensional variants using the same components, using the printer chassis for dissipating the motor and thermal head heat dissipation. This allows decreasing also the overall production costs.

The above mentioned aim is achieved by a thermal printing mechanism according to the present invention that comprises:
a printer chassis,
a thermal printhead comprising a thermal dot line arranged on a thermal printhead surface that is in contact with a platen roller, said thermal printhead being fixedly mounted on the printer chassis,
a motor for rotating a platen roller, with a motor spur gear,
a platen roller with a platen roller shaft and a platen roller gear mounted on it, said platen roller gear being a worm wheel,
pushing means arranged so as to urge the platen roller against the thermal printhead,

According to the invention said motor is mounted on the printer chassis so as its gear axis is substantially parallel to the thermal printhead surface, which is in contact with the platen roller, and perpendicular to the platen roller shaft, and the thermal printing mechanism further comprises a gear shaft mounted substantially parallel to the motor gear axis, said gear shaft having at one end a spur gear, mounted so as to engage with the motor spur gear, and at the other end—a worm screw, mounted so as to engage with the platen roller gear.

According to an advantageous variant of the present invention the platen roller is detachable from the thermal printing mechanism from a printing position to an open position, and from an open position back to a printing position.

Preferably the thermal printing mechanism also comprises at least two lateral alignment guides arranged on each lateral side of the printer chassis in order to allow the platen roller to move back and forth in a direction substantially perpendicular to the thermal printhead surface on which a thermal printhead dotline is arranged. Said lateral alignment guides are arranged on the paper guide in order to align the platen roller with the thermal printhead dotline.

According to another advantageous variant of the present invention, the urging means are springs adapted to urge the platen roller against the thermal printhead when it is in printing position.

Preferably the gear shaft is mounted on a paper guide.

Advantageously the printer chassis is metallic for rigidifying the thermal mechanism, dissipating the heat generated by the thermal printhead and the motor, and easily grounding the thermal printhead and the motor.

Preferably the printer chassis is made from at least one bend sheet metal, to generate two substantially perpendicular to each other parts with plane surfaces, and wherein the thermal printhead is mounted on a first part of the chassis and the motor is mounted on a second part of the chassis.

Preferably an engagement play between the platen roller gear and the worm screw of the gear shaft is variable. Value of said engagement play between the platen roller gear and the worm screw of the gear shaft in printing position is at least in a range defined by:
maximal engagement play, when there is no paper between the platen roller and the thermal printhead and a load value of the pushing means is maximum, so said platen roller gear and said worm screw remain engaged to each other, and
minimal engagement play, when paper with maximum thickness value is present between the platen roller and the thermal printhead and the load value of the pushing means is minimum, so said gears can engage each other without interference.

The main advantage achieved by the present invention is in decreasing the total dimensions of the thermal printing mechanism, simplifying and increasing the reliability of the construction, keeping the possibility to use the printer chassis to increase the motor heat dissipation and decreasing the overall production costs.

The proposed construction according to the present invention is especially advantageous for thermal printing mechanism that are intended to be mounted in other devices such as electronic fund transfer terminals, and other portable devices.

### BRIEF DESCRIPTION OF THE DRAWINGS

The characteristics of the invention will be disclosed in details in the following description of preferred embodiments, given as non-restrictive examples, with reference to the attached drawings wherein:

FIG. 1 is a schematic detail view of gear train of a thermal printing mechanism according to the prior art;

FIG. 2 is a view of the motor flange side of the thermal printing mechanism, called back view, of the thermal printing mechanism according to the prior art;

FIG. 3 is a schematic perspective partial view of the inner part of a preferred embodiment of the thermal printing mechanism according to the minimum width variant of the present invention;

FIG. 4 is a back view of part of the thermal printing mechanism according to the minimum width variant of the present invention;

FIG. 5 is a perspective view of the paper guide and the gear shaft in the minimum width variant of the present invention;

FIG. 6 is a perspective view of the paper guide and the gear shaft in the minimum volume variant of the present invention;

FIG. 7 is a lateral view of the thermal printing mechanism according to the prior art;

FIG. 8 is a lateral view of the thermal printing mechanism according to the minimum width variant of the present invention;

FIG. 9 is a perspective view of the platen gear side of the thermal printing mechanism according to the present invention, showing the respective lateral alignment guide for the platen roller;

FIG. 10 is a perspective view opposite to the platen gear side of the thermal printing mechanism according to the present invention, showing the respective lateral alignment guide for the platen roller;

FIG. 11 is a partial top view of the motion means area with a limited number of elements according to the present invention in the minimum volume variant;

FIG. 12 is an exploded view of the motion means according to the present invention in the minimum volume variant;

FIG. 13 is a partial top view of the motion means area according to the present invention in the minimum width variant;

FIG. 14 is an exploded view of the motion means according to the present invention in the minimum width variant;

FIG. 15 is a perspective view of the thermal printing mechanism according to the present invention in the minimum width variant, where the paper path is curved;

FIG. 16 is a perspective view of the thermal printing mechanism according to the present invention in the minimum volume variant, where the paper path is straight;

FIG. 17 is an exploded partial view of the thermal printhead and the motor mounted on the chassis;

FIG. 18 shows an exploded partial side view of the thermal printing mechanism according to present invention where the engagement play between the platen roller gear and worm screw is at its minimum value;

FIG. 19 shows an exploded partial side view of the thermal printing mechanism according to present invention where the engagement play between the platen roller gear and the worm screw is at its maximum value.

### DETAILED DESCRIPTION OF PREFERRED EMBODIMENTS

Thermal printer mechanism according to present invention comprises a printer chassis 1, a thermal printhead 2 fixedly mounted on the printer chassis, a platen roller 4 with a platen roller shaft 9, on which a platen roller gear 6 is fixedly mounted, and a platen roller motion unit that comprises a motor 3 for rotating the platen roller 4 through a gear train that engages said platen roller gear 6.

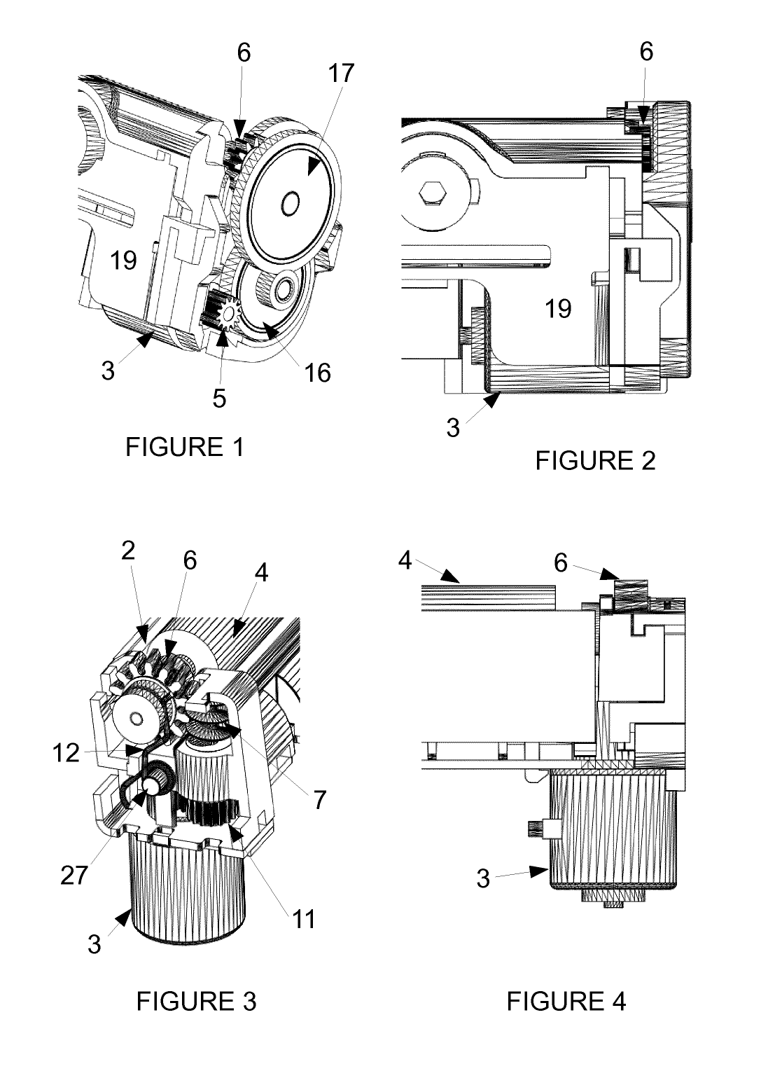

FIG. 1 shows a prior art arrangement of the platen roller motion unit where the motor 3 for rotating of the platen roller is in a vertical motor variant, i.e. the motor gear axis is substantially parallel to the platen roller shaft and is positioned below the thermal printhead. A motor spur gear 5 is driving a set of vertical spur gears 16 and 17 called a gearbox. Gear 17 drives the platen roller 4 through the gear 6 which is mounted to it. Finally, the motor is mounted on a metallic flange 19 to increase its heat dissipation.

As shown on FIG. 2, which is a back view of the thermal printing mechanism according to the prior art, a diameter of the motor is close to the thickness of the gearbox.

FIGS. 3 and 4, show an arrangement according to the present invention where in order to achieve a size reduction of the platen roller motion unit, the motor 3 is mounted so as its gear axis is substantially parallel to the thermal printhead surface, which is in contact with the platen roller 4 and on which the printhead dotline 14 is arranged, said motor gear axis being also perpendicular to the platen roller shaft 9 (as sown in FIGS. 12 and 14).

In the arrangement according to present invention, as could be seen on FIG. 4, the volume of the motor 3 is included in the volume of the gear box, as opposed to the prior art shown in FIG. 2, thus reducing the printer overall dimensions and leaving more space for other elements when the thermal printing mechanism is integrated into other device.

To achieve such arrangement, as shown on FIGS. 3, 12 and 14, a gear shaft 10, holding at one of its end a spur gear 11 and at its other end a worm screw 7, is positioned in a direction substantially parallel to the thermal printhead surface which is in contact with the platen roller 4, and at the same time perpendicular to the platen roller shaft 9, in order to adapt the gearing to the new position of the motor. In this arrangement the spur gear 11 of the gear shaft 10 engages the motor spur gear 5 and the worm screw 7 of the gear shaft 10 engages the platen roller gear 6 being a worm wheel.

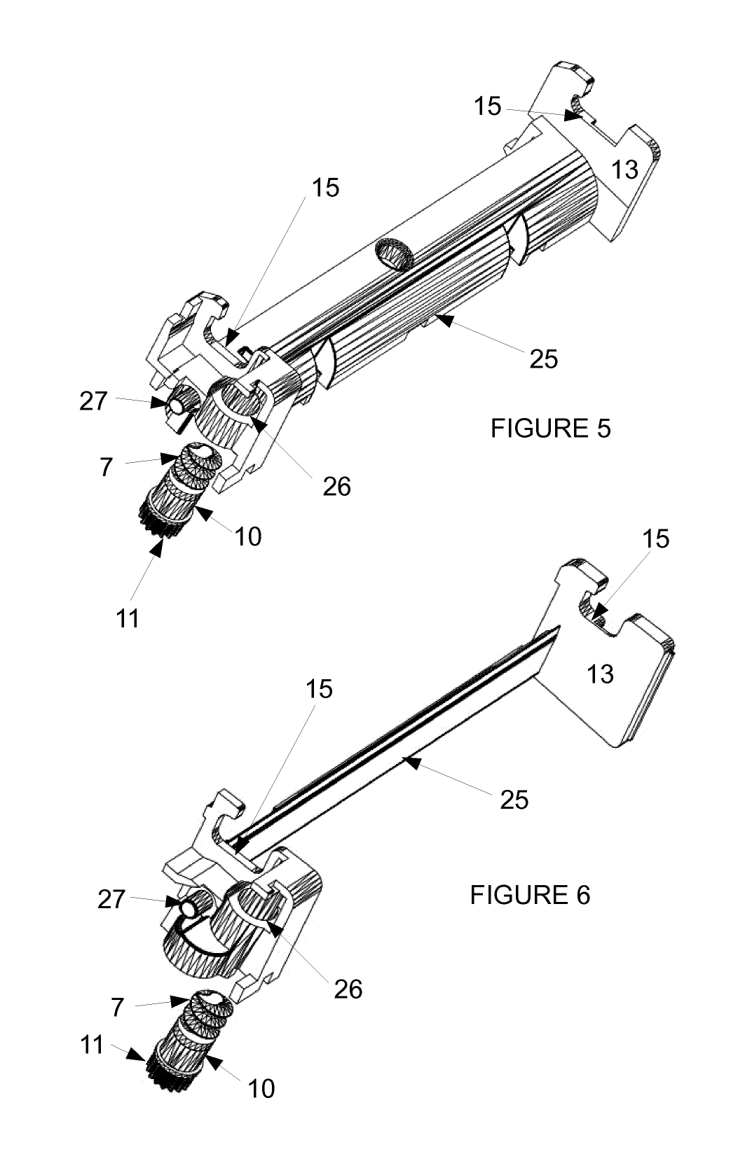

FIG. 5 shows how the gear shaft 10 is mounted into the paper guide 13 in the minimum width variant of the present invention and FIG. 6 shows how the gear shaft 10 is mounted into the paper guide 13 in the minimum volume variant of the present invention.

The paper guide 13 is mounted on the printer chassis 1, and, for example, is made of injected plastic in order to form many shapes able to receive, position or guide other elements constitutive of the thermal printing mechanism.

In both preferred variants shown in FIGS. 5 and 6 the paper guide 13 at one of its lateral sides has a supporting element 26 for the gear shaft 10. Said supporting element preferably comprises a hollow cylindrical shape 26 wherein said gear shaft 10 is inserted. Said gear shaft 10 being guided by the cylindrical shape 26 only in its central section. Preferably the gear shaft 10 diameter is big in order to have a precise and tight alignment of the worm screw into the hollow cylindrical shape 26.

In both variants a pin 27 is provided on each of the lateral sides of the paper guide 13 in order to hold the platen roller pushing means 12 (not shown on this figure).

In the minimum width variant as shown on FIG. 5, the central guiding part 25 of the paper guide 13, on which the paper is guided before being printed out, is curved in order to escape the motor volume as it will be explained below.

In the minimum volume variant as shown on the FIG. 6, the central guiding part 25 of the paper guide 13, on which the paper is guided before being printed out, is completely flat leading to a significant decrease in the thermal printing mechanism volume.

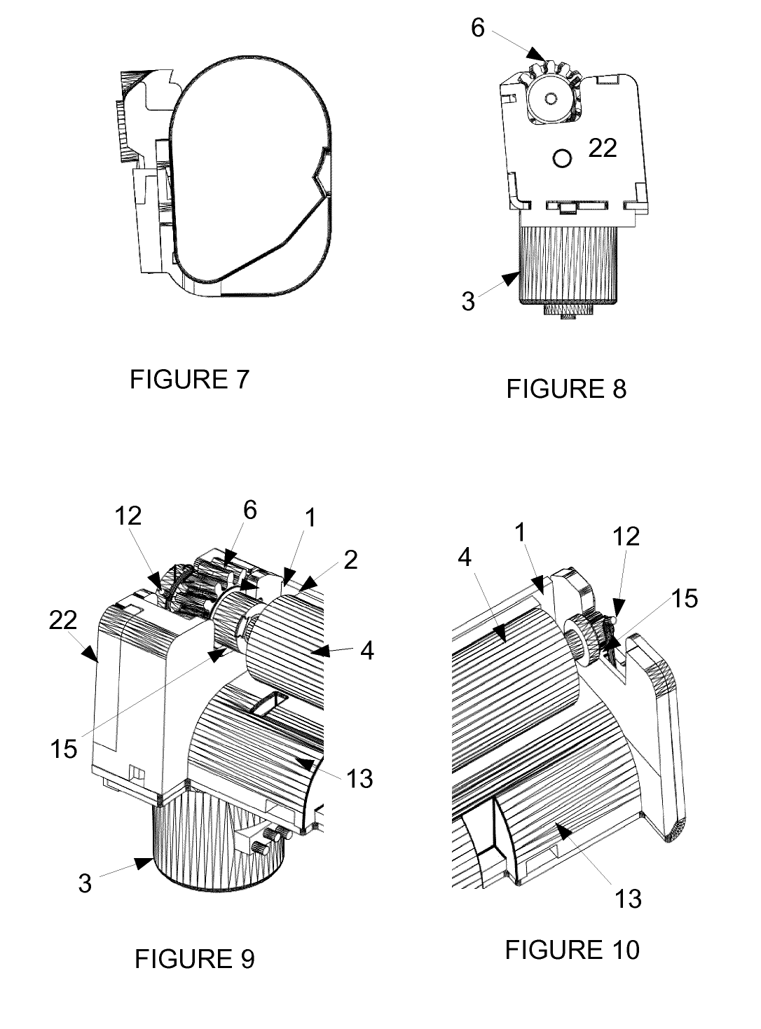

FIG. 7 and FIG. 8 illustrate the space saving on the gear side of the present invention (FIG. 8) as compared to the prior art (FIG. 7). The replacement of the spur gear 16 and 17 (as in FIG. 1) by a simple gear shaft significantly reduces the surface of this side of the printer mechanism and also the volume of the gearbox.

One other important parameter when designing a thermal printing mechanism is to keep the distance from the thermal printhead dotline to the back of the printing mechanism as small as possible. This is achieved by fixedly mounting of the thermal printhead 2 onto the chassis 1 as shown on FIG. 17. This allows very compact integration of the thermal printing mechanism into other device, into which the thermal printing mechanism should be mounted. In most of the cases, a flat element of said device is in contact with the back of the thermal printing mechanism, which can be for instance the other device housing or a liquid crystal display which is a flat element.

Finally, the last constraint is to minimize the width of the thermal printing mechanism, in order to keep the other device in which the thermal printing mechanism is mounted as narrow as possible. This gives a strong position constraint to the motor position, since it has to engage the gear shaft 10 without laterally exceeding the protector 22 of the gear shaft 10.

Such relative position of the motor 3 to the gear shaft 10 is shown on FIGS. 13 and 14. On these figures, the external side edge of the platen roller gear 6 is vertically tangent to the motor body, which is a circle on the FIG. 13. This figure, being a top view, shows that the only possible positions of the motor 3 gear axis lies on a circle whose centre is the gear shaft axis centre and whose radius is the sum of both respective spur gear pitch radiuses, since both spur gears needs to be engaged.

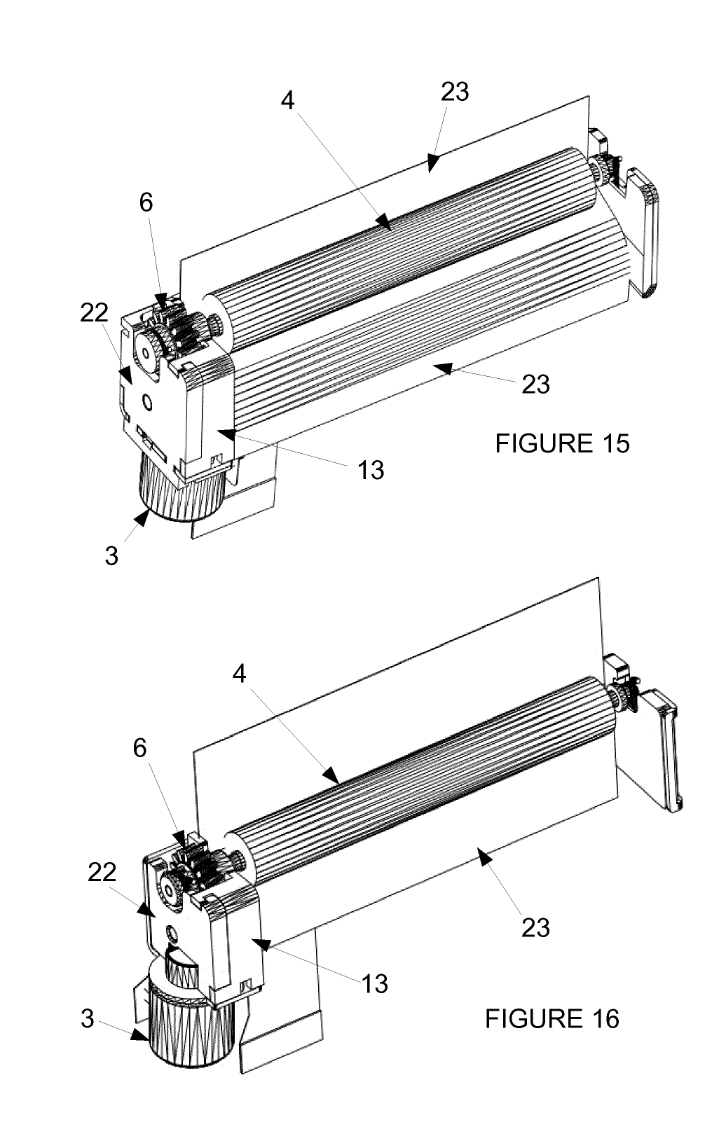

FIG. 14 shows a perspective of such embodiment that allows minimizing the width of the thermal printing mechanism. But in this embodiment, the motor 3 partially goes under the paper path, and the paper guide 13 has to guide the paper over the motor 3 and its spur gear 5 in order the paper not to interfere with the motor 3. This variant is called here a minimum width variant, but does not provide a minimum volume variant due to the curve of the paper guide 13 which generates a substantially quarter of a cylinder shape across the paper width, in order to escape the motor 3, before the paper 23 enters the thermal printing mechanism as shown on FIG. 15.

Such shape of guiding part 25 of the paper guide is shown on FIG. 5, and on FIG. 15 where the paper 23 is also present.

Another variant of the present invention aims to minimize the volume of the thermal printing mechanism with a small local increase of width of the thermal printing mechanism. This variant is called here a minimum volume variant.

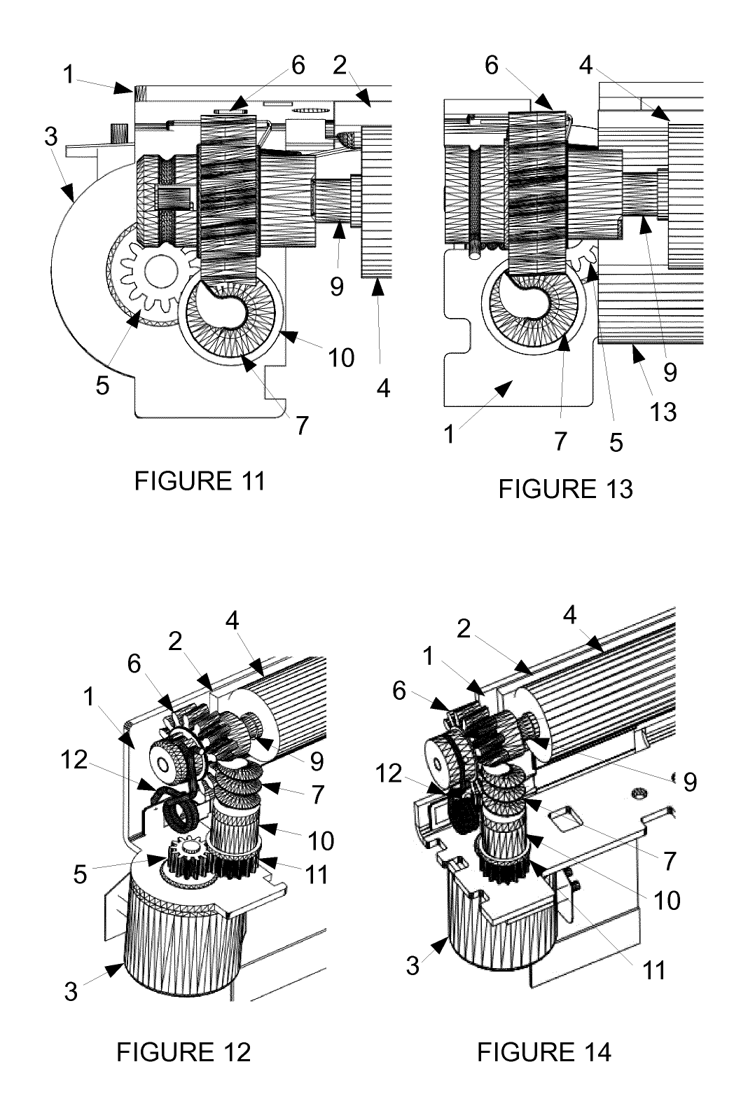

FIGS. 11 and 12 show such embodiment, where the position of the axis of the motor 3 in the construction is rotated at about 90 degrees (shown on the FIG. 11) anti clockwise towards the gear shaft 10 compared to the position of the motor axis in the variant shown on FIG. 13, so that the respective spur gears 5 and 11 remain engaged. Such arrangement of the motor 3 in this variant is in order to escape the paper path, leading to a small increase in width following in a circular shape.

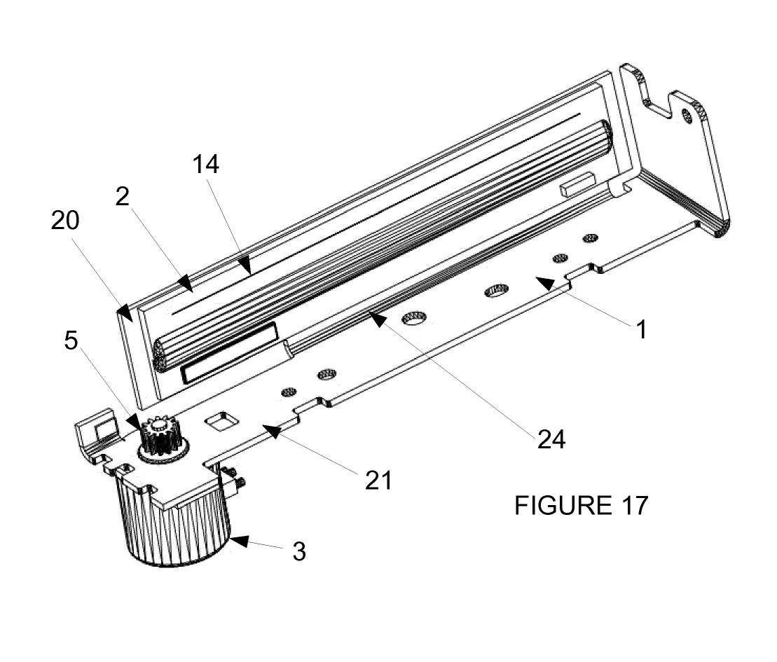

Such embodiment allows making the guiding part 25 of the paper guide 13 completely flat as shown on the FIG. 6 and offers to the paper a straight paper path as shown on FIG. 16. In this variant, the total volume of the thermal printing mechanism is minimized and this allows a very compact integration with other device even if the width of the thermal printing mechanism is a little bit increased in the motor area.

In both abovementioned embodiments, the motion means structure is identical, since they only differ by the angle of the motor position around the gear shaft axis. These embodiments allow optimization of the thermal printing mechanism width or its total volume.

In most thermal printing mechanisms known from the prior art, the thermal printhead is urged against the platen roller by urging means. In the present invention in order to simplify the overall structure and to reduce the volume of the thermal printing mechanism, the thermal printhead 2 is fixedly mounted onto the chassis 1 (FIG. 17) and the platen roller 4 is urged against the thermal printhead 2 (FIGS. 9 and 10). The platen roller 4 can move in order to be urged against the thermal printhead 2. Preferably two lateral alignment guides 15 are arranged on both lateral sides of the paper guide 13, as shown on the FIGS. 5, 6, 9 and 10, in order to keep the platen roller 4 aligned against the thermal printhead dotline 14. Each lateral alignment guide 15 comprises a flat surface and lies in a plane that is parallel to the platen roller shaft 9 and is perpendicular to the surface of the printhead 2 on which the printhead dotline 14 is arranged. The platen roller 4 can move back and forth, along said lateral alignment guides 15 in a direction perpendicular to the surface of the printhead on which the printhead dotline 14 is arranged. Such translation movement guides and aligns the platen roller 4 with the printhead dotline 14.

The platen roller 4 is urged against said surface of the printhead 2 by two lateral pushing means 12. Preferably these pushing means 12 are in shape of spring and are arranged so as to urge the platen roller 4 against the thermal printhead 2 when it is in printing position. A component of this force is used to keep the platen roller 4 in contact with the two lateral alignment guides 15 as shown in FIGS. 9 and 10.

Advantageously, the platen roller is detachable from the printer in order to facilitate the loading of the paper and its positioning between the thermal printhead and the platen roller. In such arrangement the platen roller has two positions: first one called the printing position as shown on FIGS. 15 and 16, where the platen roller is held in the printer chassis and allows the printer to print, and second one—called open position wherein the platen roller is detached from the printer chassis. In an alternative variant (not shown on the figures) the pushing means for the platen roller could be mounted on a platen roller holder.

Preferably both the thermal printhead 2 and the motor 3 are mounted on the same printer chassis 1.

Preferably, the printer chassis 1 is conductive to evacuate the electrical static load, and in order to be easily grounded.

Advantageously, and as shown on FIG. 17, the printer chassis is made of sheet metal which has at least one bend generating two substantially perpendicular to each other parts of the printer chassis with plane surfaces. The thermal printhead 2 is mounted on first part 20 of the printer chassis 1 and the motor 3 is mounted on second part 21 of the printer chassis 1, as shown on FIGS. 12, 14 and 17. Such embodiment ensures a very rigid structure for the thermal printing mechanism, and good heat dissipation for the thermal printhead 2 and the motor 3.

When the platen roller 4 rotates in the printing direction, the worm screw 7 applies to the platen roller 4 a force in a direction substantially parallel to the gear shaft 10, and in the direction of the motor 3, so urging the platen roller 4 against the lateral alignment guides 15 of the printer chassis 1, thus increasing the engagement of the platen roller gear 6 into the worm screw 7.

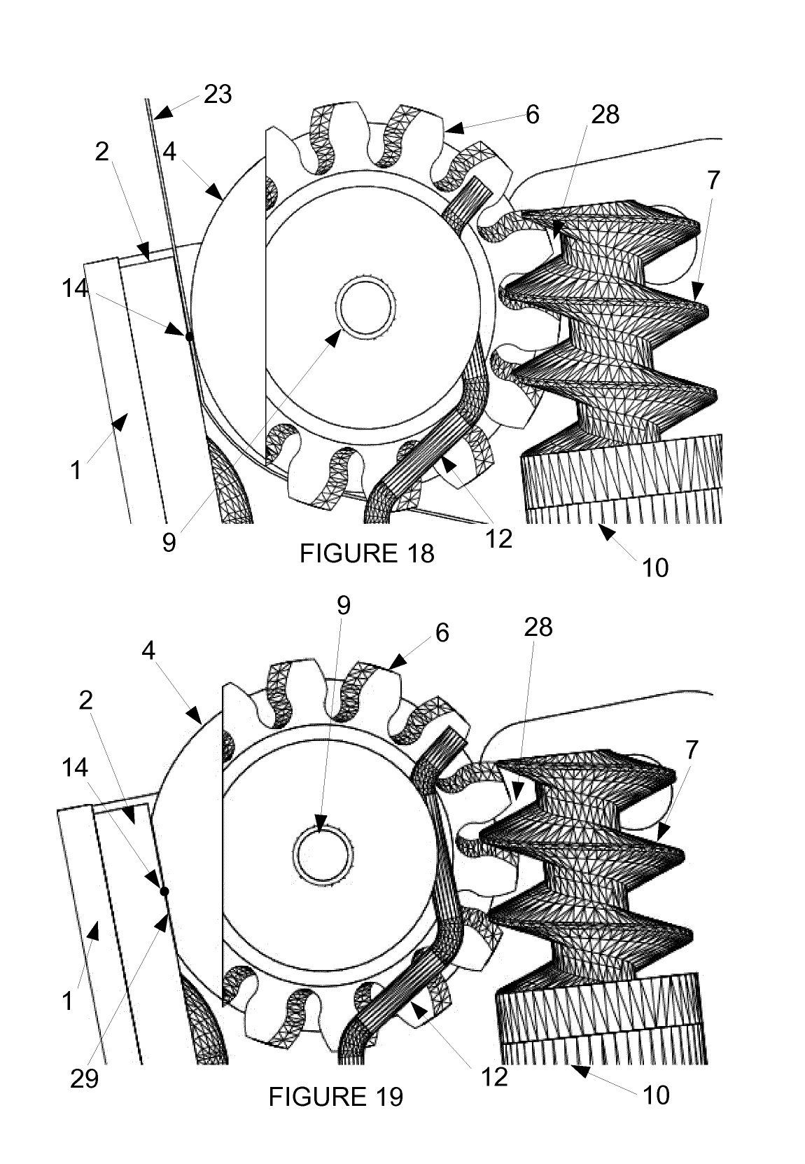

Since the platen roller 4 is able to move along the lateral alignment guide 15 and simultaneously the platen roller gear 6 engages the worm screw 7, the engagement play between these two gears is variable. FIGS. 18 and 19 shows the two extreme configuration of such engagement play to allow the printing mechanism to operate. For an easier understanding the platen roller gear 6 is represented partly cut on its thermal printhead 2 side.

Therefore the platen roller gear 6 and the worm screw 7 of the gear shaft 10 should be arranged so as that the value of the engagement play 28 should be at least in a range between:
minimal engagement play, when paper with maximum thickness is present between the platen roller 4 and the thermal printhead 2 and the load value of the pushing means 12 is minimum and accordingly the distance between the axis of the platen roller shaft 9 and the axis of the worm screw 7 is minimal, so the platen roller gear 6 engages without interference with the worm screw 7, and
maximal engagement play, when there is no paper between the platen roller 4 and the thermal printhead 2 and a load value of the pushing means 12 is maximum and accordingly the distance between the axis of the platen roller shaft 9 and the axis of the worm screw 7 is maximal, so said gears still remain engaged to each other.

The engagement play depends on two parameters which are
the paper thickness which stands between the platen roller 4 and the thermal printhead 2, and
the deformation of the platen roller 4 when submitted to the load of the pushing means 12.

Such pushing means have a tolerance when they are manufactured and their value has to compromise with the motor power, the paper thickness to be printed on and also the print quality and the noise level to be obtained. The load value may widely vary from one application to another and have in any case a tolerance for a given application. When the platen roller 4 is pushed against the thermal printhead 2, the respective contacting side of circumferential surface of the platen roller 4 is deformed into a flat area 29. The change in the load of pushing means directly modifies the deformation of the platen roller 4 and the surface of the flat area 29 of contact between the platen roller 4 and the thermal printhead 2.

If the load of the pushing means 12 is at a minimum value, the platen roller 4 is not deformed, and if additionally the paper is present, the distance between the platen roller shaft 9 and the thermal dotline 14 is at its maximum possible value. FIG. 18 shows such configuration where the engagement play 28 between the platen roller gear 6 and the worm screw 7 is minimal engagement play.

If the load of the pushing means increases, the flat area 29 of the platen roller in contact with the thermal printhead increases, and the platen roller shaft 9 gets closer to the printhead dotline 14, leading to an increase in the engagement play 28 as shown on the FIG. 19.

On this FIG. 19, the paper is not present, decreasing again the distance from the platen roller shaft 9 to the thermal printhead dotline 14. This is configuration where the engagement play 28 is at its maximum possible value and where the platen roller gear 6 must remain engaged in the worm screw 7.

The gear module for gears 6 and 7 must be big enough chosen in order to cover both case as shown on FIG. 18 and FIG. 19, and the shape of the worm screw 7 can be modified in order to increase the engagement play.

The advantage of using a worm screw is that being a friction gear, there is no loss of contact between the platen roller gear 6 and the worm screw 7, whatever is the engagement play value. This allows keeping the noise low and a continuous smooth gear movement to obtain a good printout quality.

Various modifications and/or additions of parts will be apparent to those skilled in the art that will remain within the field and scope of the present invention defined in appended claims. All the parts may further be replaced with other technically equivalent elements.

Reference signs for technical features are included in the claims for the sole purpose of increasing the intelligibility of the claims and accordingly, such reference signs do not have any limiting effect on the interpretation of each element identified by way of example by such reference signs.

1. A thermal printing mechanism comprising:
a printer chassis,
a thermal printhead comprising a thermal dotline arranged on a thermal printhead surface that is in contact with a platen roller, said thermal printhead being fixedly mounted on the printer chassis,
a motor for rotating a platen roller, with a motor spur gear, a platen roller with a platen roller shaft and a platen roller gear mounted on it, said platen roller gear being a worm wheel,
pushing means arranged so as to urge the platen roller against the thermal printhead,
said motor being mounted on the printer chassis so as its gear axis is substantially parallel to the thermal printhead surface, which is in contact with the platen roller, and perpendicular to the platen roller shaft, and
in that the thermal printing mechanism further comprises a gear shaft mounted substantially parallel to the motor gear axis, said gear shaft having at one end a spur gear, mounted so as to engage with the motor spur gear, and at the other end
a worm screw, mounted so as to engage with the platen roller gear.

2. The thermal printing mechanism according to claim 1, wherein the platen roller is detachable from the printer chassis.

3. The thermal printing mechanism according to claim 1, wherein the pushing means are springs.

4. The thermal printing mechanism according to claim 1 wherein the printer chassis is conductive.

5. The thermal printing mechanism according to claim 4 wherein the chassis is a sheet metal having at least one bend arranged so as to generate two substantially perpendicular to each other parts with plane surfaces, and wherein the thermal printhead (2) is mounted on a first part (20) of the chassis and the motor is mounted on a second part of the chassis.

6. The thermal printing mechanism according to claim 1, wherein the thermal printing mechanism comprises at least two lateral alignment guides arranged on each lateral side of the printer chassis in order to allow the platen roller to move back and forth in a direction substantially perpendicular to the thermal printhead surface on which a thermal printhead dotline is arranged.

7. The thermal printing mechanism according to any of claim 6 wherein an engagement play between the platen roller gear and the worm screw of the gear shaft is variable.

8. The thermal printing mechanism according to claim 7, wherein value of the engagement play between the platen roller gear and the worm screw of the gear shaft in printing position is at least in range defined by:
maximal engagement play, when there is no paper between the platen roller and the thermal printhead and a load value of the pushing means is maximum, so said platen roller gear and said worm screw remain engaged to each other, and
minimal engagement play, when paper with maximum thickness value is present between the platen roller and the thermal printhead and the load value of the pushing means is minimum, so said gears can engage each other without interference.
